(19) United States
(12) Patent Application Publication
(10) Pub. No.: US 2026/0211973 A1
(43) Pub. Date: Jul. 23, 2026

(54) MULTI-QUEUE DATA TRANSFER FOR AI ACCELERATION

(71) Applicant: NVIDIA Corporation, Santa Clara, CA (US)

(72) Inventors: Markus Hohnerbach, Santa Clara, CA (US); Biao Wang, Shanghai (CN); Wenzhi Yin, Shanghai (CN); Tianyou Guo, Beijing (CN); Kai Zhu, Beijing (CN); Sunghyun Park, Seattle, WA (US); Justin Hsuanting Wang, San Jose, CA (US); Yi Qian, Shanghai (CN); Anand Venkat, San Jose, CA (US)

(21) Appl. No.: 19/314,102

(22) Filed: Aug. 29, 2025

Related U.S. Application Data
(63) Continuation of application No. PCT/CN2025/074345, filed on Jan. 23, 2025.

(30) Foreign Application Priority Data
Jan. 23, 2025 (WO) PCT/CN2025/074345

(51) Int. Cl. G06F 17/16

(52) U.S. Cl. CPC G06F 17/16

(57) ABSTRACT

Apparatuses, systems, and techniques to cause a plurality of queues to be created and operations to be performed using the plurality of queues. In at least one embodiment, a processor comprises circuitry to cause a plurality of queues to be created between a first set of threads and a second set of threads, and cause the second set of threads to begin performing operations on a portion of data received from the first set of threads through a first queue of the plurality of queues, while one or more other portions of the data are being transmitted through one or more other queues of the plurality of queues.

### CROSS-REFERENCE TO RELATED APPLICATIONS

This application claims the benefit of International Application No. PCT/CN2025/074345 (Attorney Docket No. 0112912-E91WO0) titled “REDUCING COMMUNICATION LATENCY IN NEURAL NETWORKS,” filed Jan. 23, 2025, the contents of which are hereby incorporated by reference in their entirety.

### TECHNICAL FIELD

At least one embodiment pertains to using a plurality of queues to perform one or more operations of one or more neural networks.

### BACKGROUND

Language models, such as large language models (LLMs), can generate large amounts of data when processing input sequences. Efficiently processing this data can be a difficult task, such as in scenarios with multiple sets of threads involved. The amount of memory, time, or computing resources used to perform operations of language models can be improved.

### BRIEF DESCRIPTION OF THE DRAWINGS

FIG. 1 is a block diagram of an example system to generate optimized producer-consumer operations, in accordance with some embodiments of the present disclosure.

FIG. 2 is a block diagram illustrating one or more processes of a compiler to optimize producer-consumer operations, in accordance with some embodiments of the present disclosure.

FIG. 3 is a block diagram illustrating optimized producer operations and optimized consumer operations, in accordance with some embodiments of the present disclosure.

FIG. 4 is a flow diagram illustrating a process of modifying code of a neural network to generate multiple queues, in accordance with at least one embodiment of the present disclosure.

FIG. 5 is a flow diagram illustrating a process of modifying code of a neural network to enable operations to be performed using multiple queues, in accordance with at least one embodiment of the present disclosure.

FIG. 6A is a block diagram of an example generative language model system suitable for use in implementing at least some embodiments of the present disclosure.

FIG. 6B is a block diagram of an example generative language model that includes a transformer encoder-decoder suitable for use in implementing at least some embodiments of the present disclosure.

FIG. 6C is a block diagram of an example generative language model that includes a decoder-only transformer architecture suitable for use in implementing at least some embodiments of the present disclosure.

FIG. 7 is a block diagram of an example computing device suitable for use in implementing at least some embodiments of the present disclosure.

FIG. 8 is a block diagram of an example data center suitable for use in implementing at least some embodiments of the present disclosure.

### DETAILED DESCRIPTION

In an embodiment, techniques described herein reduce communication latency in an attention module of a transformer-based neural network (e.g., a language model, such as an LLM). In the various implementations of an attention module, such as a fused multi-head attention (FMHA) module, a producer agent computes a full tile of data and stores it into tensor memory using one or more store instructions. Once the entire tile is written, the producer may signal readiness via a single queue put operation. A corresponding consumer agent may then perform a queue get operation on the same queue and block until the entire tile is received. Only then can the consumer begin issuing compute instructions, such as a series of tensor core matrix multiply-accumulate (MMA) instructions. This one-shot synchronization model creates a communication bottleneck, as the consumer remains idle during the full memory write, reducing opportunities for overlapping computation and data movement.

To overcome this limitation, a compiler may perform optimizations such as described herein to transform the communication pattern between producer and consumer agents in an attention module of a transformer-based neural network by replacing a single queue with multiple smaller queues. Each smaller queue may be utilized to transmit a portion of the original tile. This transformation enables finer-grained synchronization, allowing the consumer agent to begin partial computation as soon as a first portion of the tile is received, rather than waiting for the entire tile. For example, if the consumer can issue a first group of four MMA instructions after receiving 64 out of 128 elements, the compiler splits the original tile into two 64-element tiles, and generates two asynchronous queues accordingly. This reduces blocking time and improves resource utilization on the GPU.

The compiler begins by analyzing input code that represents producer-consumer operations in the neural network (e.g., language model). Upon identifying producer and consumer instructions, the compiler may determine the minimum amount of data required for the consumer agent to initiate useful work or otherwise perform operations on the data. This minimum data threshold may be computed based on one or more of three primary factors. First, the compiler may consider the dimensionality of the attention head, or head size, which determines the amount of data processed by each attention unit in the FMHA module. Second, the compiler may consider the store granularity of the hardware architecture, which places an upper limit on how many elements can be written to tensor memory in a single store instruction. Third, the compiler may apply a heuristic that examines instruction-level granularity at the consumer side, such as the number of MMA instructions that can be executed per partial tile.

Using these constraints, the compiler may generate instructions that divide the original tensor tile into sub-tiles using tensor slice operations at the producer side. Each sub-tile may be stored into tensor memory and linked to a distinct queue put operation. At the consumer side, the compiler generates corresponding queue get operations for each sub-tile, allowing the consumer agent to begin partial computation as soon as the first queue synchronization completes. The consumer may then complete remaining computations once subsequent sub-tiles are received. This approach may enable overlapping communication and computation, significantly reducing latency between execution stages.

The final output of the compiler includes transformed producer and consumer code segments that operate over multiple queues, rather than a single monolithic queue. These multiple queue operations allow for asynchronous, pipelined communication between agents, and can be tuned to reflect the architectural characteristics of the target GPU platform.

In the preceding and following description, numerous specific details are set forth to provide a more thorough understanding of at least one embodiment. However, it will be apparent to one skilled in the art that the inventive concepts may be practiced without one or more of these specific details.

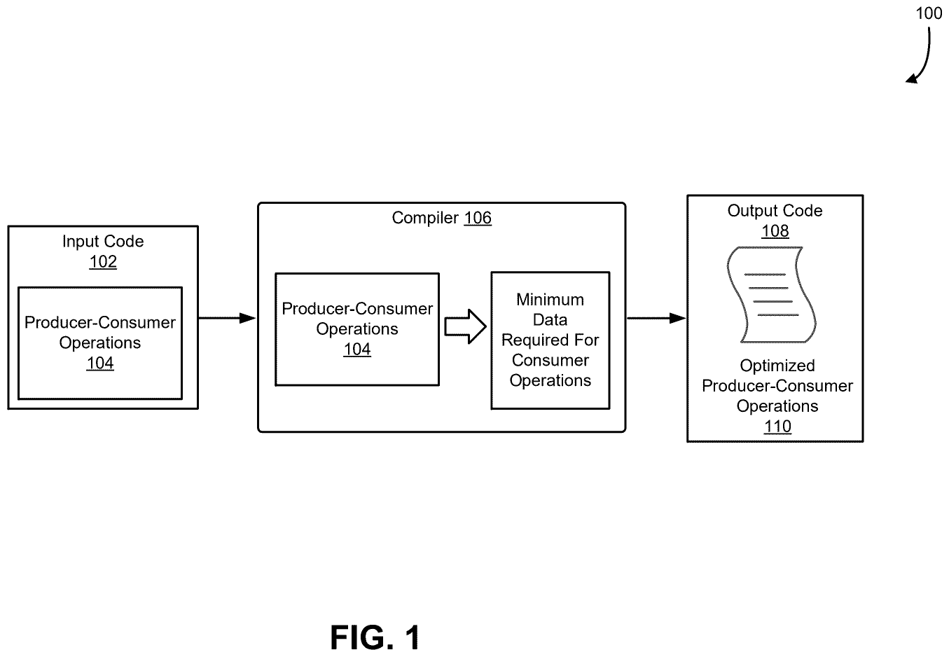

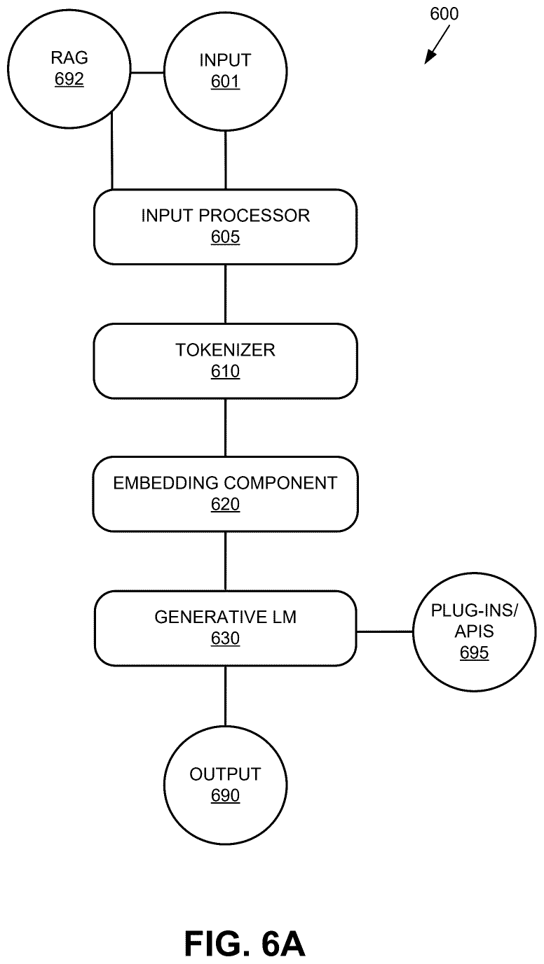

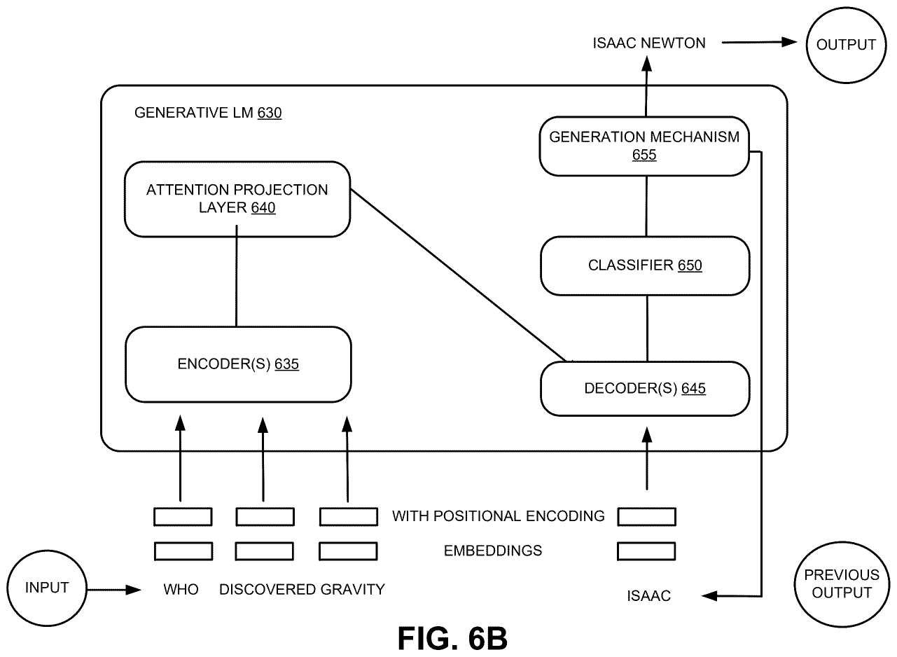

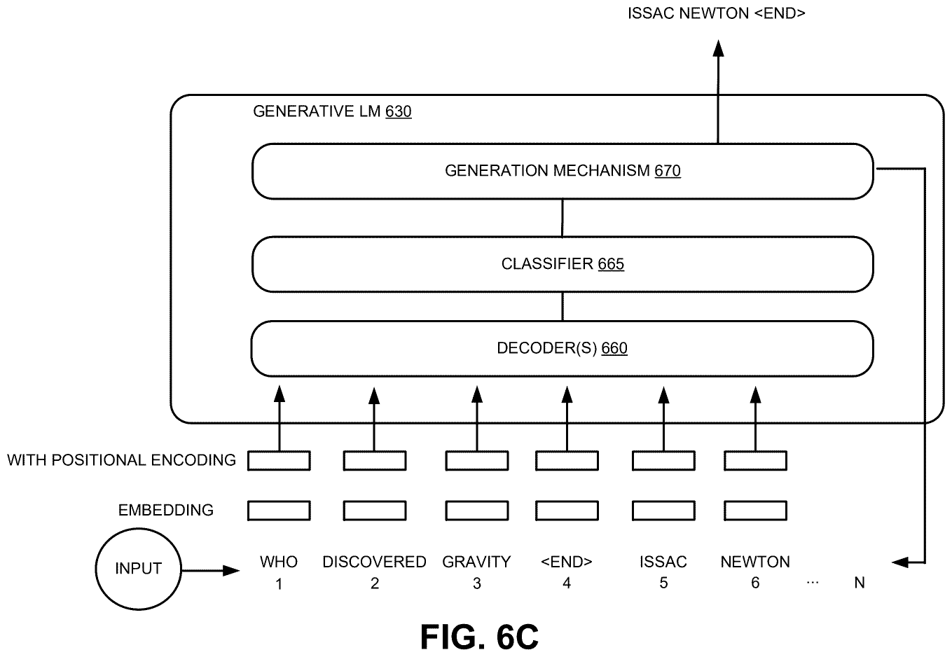

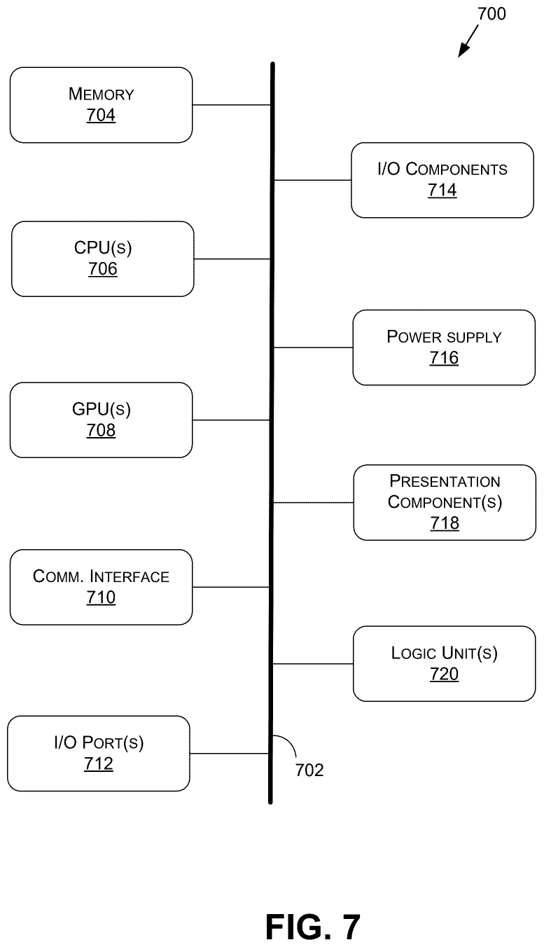

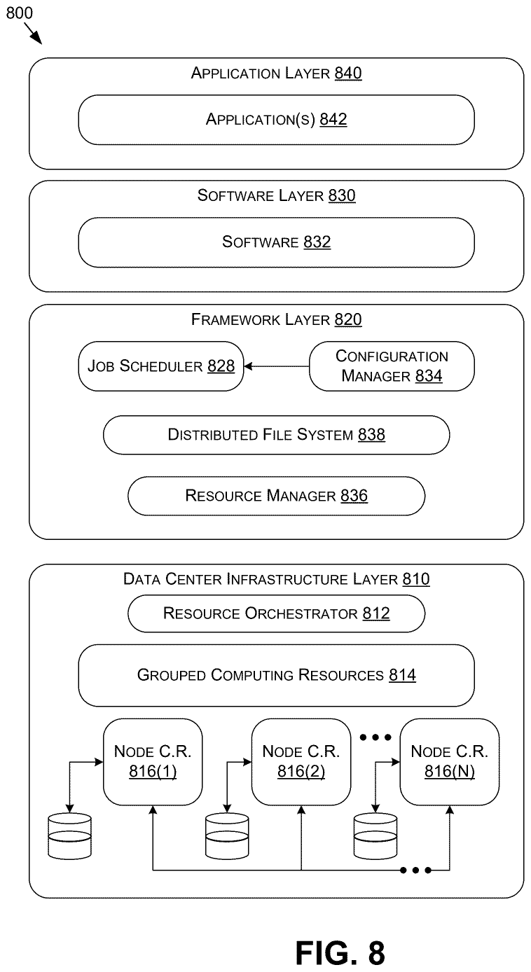

With reference to FIG. 1, FIG. 1 is a block diagram of an example system to generate optimized producer-consumer operations, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some embodiments, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

System 100 may use a compiler 106 to convert input code 102 to output code 108. Input code 102 may be code that represents a transformer-based neural network or a portion thereof. The neural network may be a language model such as a large language model (LLM) or other model such as described herein. As an illustrative example, input code 102 may be code that represents a fused multi-head attention (FMHA) module of the LLM, which enables the LLM to focus on different parts of an input sequence simultaneously, enhancing its ability to learn contextually rich representations. An MHA module may operate by applying learned linear transformations to the input tensor to produce the query (Q), key (K), and value (V) matrices. These projections may be performed independently for each attention head. The attention mechanism for each head computes a similarity score between the queries and keys (e.g., using a scaled dot product, to determine the relevance of each key to a given query). These scores may then be passed through a softmax function to obtain normalized attention weights. The resulting weights may be applied to the values tensor, producing a context vector for each position in the input sequence. In a FMHA module, the above process may be performed or otherwise executed in parallel across multiple attention heads. Each head captures different aspects of the input by operating with separate learnable projections for Q, K, and V. The outputs from all heads may then be concatenated and passed through a final linear transformation to produce the module's output. This multi-headed mechanism enables the model to attend to information from various representation subspaces and positions simultaneously.

In some examples, the process within the FMHA module involves a number of execution agents, each of which may represent a logical execution unit assigned to perform a specific stage or sub-task within a larger computation pipeline. Each agent may correspond to one or more warps within a cooperative thread array (CTA), and be specialized for a distinct operation, such as matrix multiplication, softmax normalization, or memory load/store. In an embodiment, a warp is a set of threads (e.g., 32 threads), which can also be referred to as a subgroup or wavefront, where each thread in the set of threads can belong to a single thread block and is configured to process a different set of data based on a single set of instructions. In some examples, a CTA is a group of GPU threads that work together to execute a block of code and share resources like memory and synchronization primitives. A CTA may include multiple warps of threads. These agents may operate together within the same kernel but may not execute the entire computation sequentially. In some embodiments, the agents operate in parallel, communicating asynchronously through queues or shared memory.

In various embodiments, a thread is used to describe a basic unit of execution within a processing system. In some embodiments, a thread may refer to a sequence of instructions that can be executed independently by a processing unit. For example, a thread may be implemented as one or more operations performed by a processing unit, such as a CPU, GPU, or another form of computational hardware. In some implementations, a thread represents the smallest schedulable unit of execution on a processor. Each thread may carry its own execution context, including but not limited to a program counter, register values, and stack information, allowing the processing unit to switch between threads or execute them concurrently. In some embodiments, a thread may also be implemented as a data structure or other form of representation that encodes instructions to be performed by a processor. In some embodiments, a thread may be a hardware-level thread (e.g., a hardware-executed instruction stream). In some embodiments, a thread may be a software-level thread (e.g., a thread managed by an operating system).

As an illustrative example, an input sequence may be divided into multiple tiles, with each tile representing a fixed-size portion of the sequence and all tiles having the same size. In a pipelined parallelism manner, while agent A is processing tile 2, agent B may already be working on tile 1, and agent C on tile 0, with each agent handling a different stage of the pipeline on a different piece of data simultaneously. Agent A begins by computing the QK matrix multiplication for tile 0 and passes its results to agent B, which performs the softmax computation. As agent B starts processing tile 0 of the QK matrix, agent A immediately moves on to tile 1 of the QK matrix. Once tile 0's softmax output is ready, agent C begins the matrix multiplication with the V tensor. While agent C works on tile 0 of the QK matrix, agent B advances to tile 1 of the QK matrix, and agent A proceeds to tile 2 of the QK matrix. In this way, each agent operates independently across tiles and computation stages, forming a continuous pipeline where no agent needs to wait for the entire batch to complete before proceeding.

In an embodiment, an agent that provides data to another agent is referred to as a producer agent, or simply a producer. In an embodiment, an agent that receives data from a producer agent is referred to as a consumer agent, or simply a consumer. In some examples, since each producer agent or consumer agent corresponds to one or more GPU warps within a CTA, a producer agent may also be referred to as a producer warp, and a consumer agent as a consumer warp. In some embodiments, an agent may refer to one or more instructions or operations that are being performed or otherwise executed by one or more processing units (e.g., as part of one or more threads), in which the instructions or operations can be generated in connection with a compiler through processes such as those described herein.

In the pipeline of the illustrative example described above, agent A is a producer agent with respect to agent B, which is a consumer agent in relation to agent A. At the same time, agent B acts as a producer agent with respect to agent C. Each producer or consumer agent may be implemented using one or more instructions, functions, or modules written in various programming languages, such as C/C++ or Python. Each producer agent or consumer agent can perform one or more operations. Producer-consumer operations 104 comprise operations performed by a pair of producer and consumer agents to produce and consume data in the above-described pipeline. For example, producer-consumer operations 104 may include one or more operations performed by a producer agent (e.g., agent A) to generate data (e.g., a tile of a QK matrix) to be transmitted to a corresponding consumer agent (e.g., agent B) via a single queue, as well as one or more operations performed by the consumer agent to consume the tile. More specifically, a producer agent, such as a softmax agent, may perform a sequence of operations to generate and transmit data to a corresponding consumer agent, such as a math agent responsible for matrix multiplication. The producer agent begins by computing a tile of data, for example, a 128-element tensor of softmax results in fp16 precision. Following this computation, the producer agent executes one or more store instructions to write the computed tile into tensor memory. Due to hardware constraints, a single store instruction can write a maximum of 64 fp16 elements, requiring two store instructions to complete the transfer of the entire tile. At the consumer side, the consumer agent performs a queue get operation on a single queue to retrieve the entire tile before the consumer agent may begin issuing MMA instructions, initiating computation on the tile. As used herein, a queue refers to a compiler-generated communication construct that enables asynchronous data transfer and synchronization between a producer agent and a consumer agent. For example, a queue may be first-in-first-out (FIFO) queue, which is a data structure with an enqueue (put) and dequeue (get) operations.

One problem with the single queue configuration in input code 102 is the communication latency between producer and consumer agents, where a consumer agent must wait until the entire tile of data is received from the producer agent before the consumer agent can begin computation, which creates communication overhead and underutilizes GPU compute resources.

Compiler 106 may modify input code 102 to cause it to include multiple smaller queues between a producer agent and a consumer agent. Output code 108 is the modified code that includes multiple smaller queues (e.g., instructions to generate multiple smaller queues), and may be performed by one or more processors to use the multiple smaller queues to reduce communication latency in the neural network. Compiler 106 may convert input code 102, which may be written in C/C++ or Python, into intermediate representation (IR) code. One example of the IR code is parallel thread execution (PTX) code. In at least one embodiment, another example of the IR code is Advanced Micro Devices(AMD) low level virtual machine (LLVM) IR code, or Virtual Instruction Set Architecture (vISA) code. Compiler 106 may analyze producer-consumer operations 104 to determine a minimum data size required by a corresponding consumer agent to perform one or more operations, and may use this size to convert a single queue between a producer agent and a consumer agent into two or more queues. Each of the two or more queues may have a size equal to the determined minimum data size. The size of a queue may refer to the amount of data (e.g., measured bytes) that the queue can hold or transmit before blocking or requiring synchronization or any suitable indication of a size or capacity. The size of a queue may represent the payload capacity per communication round between the producer and consumer agents connected by the queue. By using multiple queues between a producer and consumer agent, the consumer agent can begin processing a tile of data received via the first queue while one or more additional tiles are being transmitted through one or more other queues. This enables overlapping of communication and computation, thereby reducing communication latency.

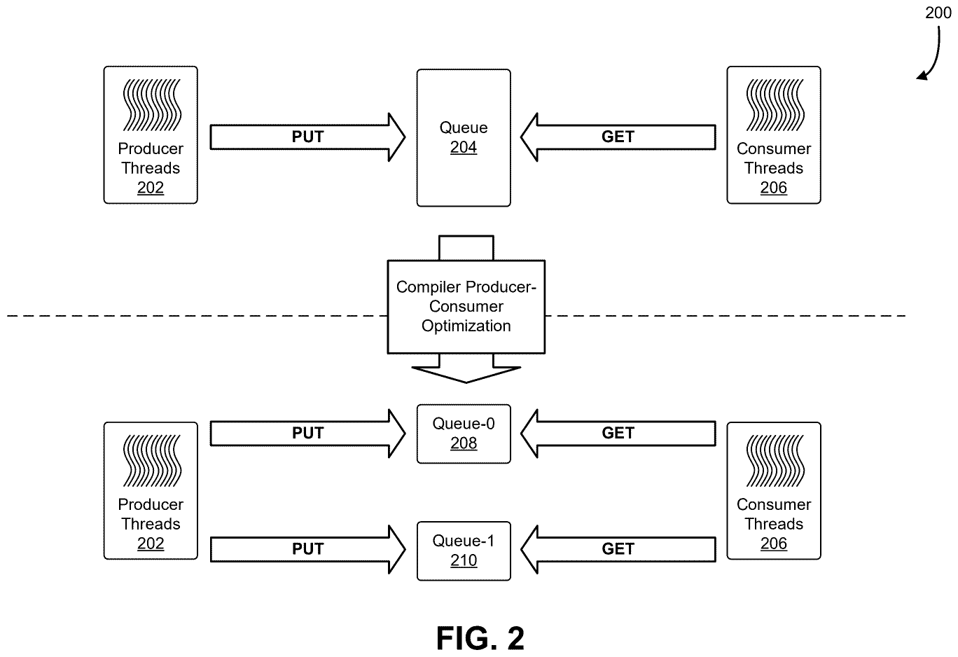

With reference to FIG. 2, FIG. 2 is a block diagram illustrating one or more processes of a compiler to optimize producer-consumer operations, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

Queue 204 may be a queue indicated in input code, such as input code 102 as described in connection with FIG. 1. The input code may be performed by producer threads 202 and consumer threads 206, which correspond to a producer agent (producer warp) and a consumer agent (consumer warp), respectively, as described in connection with FIG. 1. Compiler producer-consumer optimization may be one or more processes performed by a compiler, such as compiler 106 as described in connection with FIG. 1. The compiler can modify the input code to cause it to include instructions to generate two queues 208 and 210 between producer threads 202 and consumer threads 206. In some embodiments, the output of the compiler may include instructions to generate three or more queues. As shown in FIG. 2, queues 208 and 210 are between a set of producer threads 202 and a set of consumer threads 206. A queue may be considered to be between a first set of threads and a second set of threads when the queue is accessible to processing units (e.g., streaming multiprocessors or SMs) that are performing the two sets of threads. That is, the queue provides a communication and synchronization mechanism that allows a producer thread in the first set to write data that can later be read by a consumer thread in the second set. In some embodiments, each set of threads operates independently but is coordinated via the queue, which bridges the two sets of threads by serving as a shared buffer in memory that both sets can access. This configuration enables data to flow asynchronously from one set of executing threads to another set of executing threads without requiring the threads to execute in lockstep, thus supporting pipelined execution and reducing idle time.

Each producer thread can perform a put operation on one or more of queues 208 and 210. Each consumer thread can perform a get operation on one or more of queues 208 and 210. As used herein, a put operation may refer to one or more producer-side instructions that enqueue one or more portions of data onto one or more of queues 208 and 210 to signal availability for consumption by a downstream agent, such as an agent being performed in connection with consumer threads 206. In an embodiment, the put operation causes the data, which may be generated by a producer thread executing a computation (e.g., softmax or matrix multiplication), to be stored into a communication buffer (e.g., a compiler-generated asynchronous queue). The put operation may also notify one or more of queues 208 and 210 that the data is ready for retrieval, enabling subsequent operations to proceed without blocking the producer thread executing the computation. A get operation may refer to one or more consumer-side instructions that dequeues or retrieves data from one or more of queues 208 and 210. The get operation may be issued by a thread in the set of consumer threads 206 and block execution until the one or more queues signal that the required portion of data has been received and is ready to be read. Once the data is available, the consumer thread may retrieve the data and can begin issuing dependent instructions, such as tensor core MMA operations, using the retrieved tile. In some embodiments, multiple get operations may be issued in sequence to retrieve sub-tiles of a tensor, allowing partial execution to begin before the full tile is received, thus enabling fine-grained communication-computation overlap.

In an embodiment, the compiler determines the size of a queue based on a minimum portion of a tile that needs to be transmitted from a producer agent to a consumer agent before the consumer agent can initiate computation. At least three factors may be used to define queue size. The compiler may determine the minimum portion of a tile based, at least in part, on a dimensionality of the feature space processed by each attention head within an FMHA module. This dimensionality, referred to as head size, may indicate how much of the input tensor each attention head consumes, thereby influencing the shape and alignment of data tiles communicated between producer and consumer agents. The compiler may use head size to establish the minimum data granularity required for a downstream execution unit (e.g., a consumer agent) to begin issuing instructions.

The compiler may determine the queue size based on the store granularity associated with one or more store instructions. In some embodiments, the store granularity defines the maximum number of elements or bytes that can be stored into tensor memory in a single instruction on a target architecture. For example, in GPUs supporting a granularity of 64 fp16 elements per store, the compiler may partition a tile of 128 elements into two sub-tiles of 64 elements each, generating two queues accordingly. This may ensure that each queue corresponds to a fully realizable memory transaction and enables partial tile transfers to be aligned with native store operations, facilitating earlier data availability at the consumer.

The compiler may apply a heuristic to identify a minimum quantity of data sufficient to unblock the consumer's initial instructions. This threshold may account for both the execution granularity of consumer-side compute units (e.g., number of MMA instructions per tile) and the structure of the data dependencies across producers and consumers. If, for example, the consumer may begin processing after receiving 64 elements of a 128-element tile, the compiler partitions the tile accordingly and generates two queues, each capable of transmitting a portion aligned with instruction boundaries. In some examples, this heuristic enables finer-grained synchronization by ensuring queue sizes are just large enough to trigger meaningful downstream computation without introducing unnecessary delay.

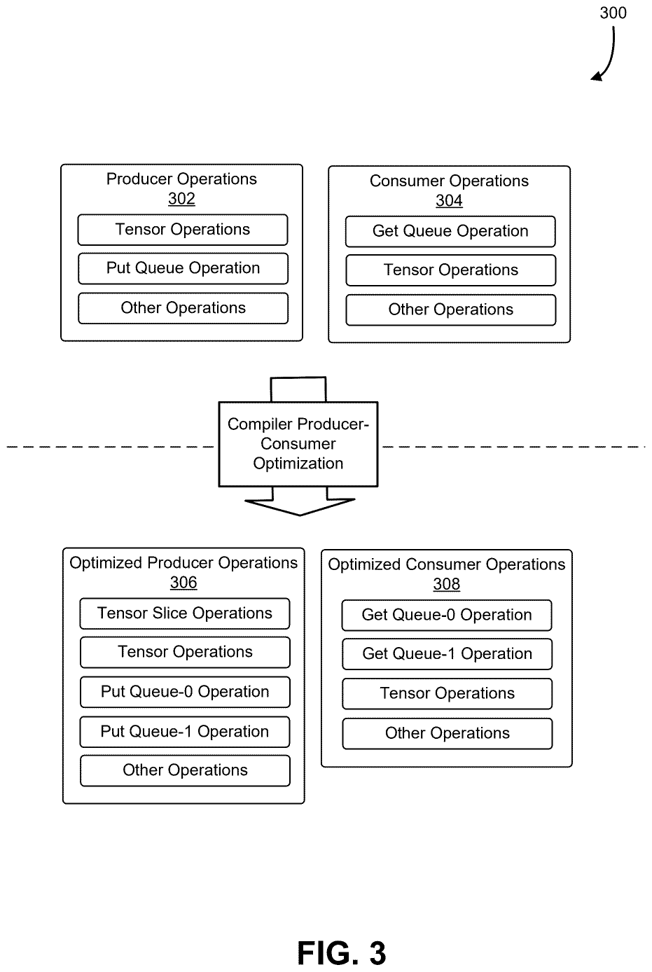

With reference to FIG. 3, FIG. 3 is a block diagram 300 illustrating optimized producer operations and optimized consumer operations, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

Compiler producer-consumer optimization may refer to one or more processes performed by a compiler, such as described in connection with FIGS. 1 and 2. The compiler may perform the optimization to convert producer operations 302 and consumer operations 304 into optimized producer operations 306 and optimized consumer operations 308. In an embodiment, producer operations 302 include tensor operations, a queue put operation, and other operations executed or otherwise performed by a producer agent, such as a softmax operation. A producer agent performs computations on a tensor tile, for example, a tile comprising 128 fp16 (2-byte) elements. In producer operations 302, the producer agent may store the full tile into tensor memory and issue a single queue put operation to signal readiness to a consumer agent.

In an embodiment, consumer operations 304 include a queue get operation, tensor operations, and other operations executed or otherwise performed by the consumer agent, such as a math agent responsible for issuing tensor core matrix-multiply (MMA) instructions. The consumer agent may issue a single queue get operation and block until the entire tile is available, at which point the agent may executes a sequence of MMA instructions, such as eight instructions to consume the 128-element tile across the reduction (K) dimension.

The compiler may transform the original queue structure to enable finer-grained synchronization and communication-computation overlap. The compiler may apply a heuristic to determine a minimum data threshold required for the consumer agent to initiate a partial computation (e.g., the first four MMA instructions, and map that threshold to a partition of the original tile). The compiler may also determine a threshold based on the store granularity of the architecture, which may impose a maximum of 64 fp16 elements per tensor memory store instruction. Accordingly, the compiler may generate instructions to split the original 128-element tile into two 64-element tiles, and generate two queues to transmit each tile independently.

Optimized producer operations 306 include tensor slice operations that partition the original tile using, for example, extract_slice instructions. The resulting smaller tiles may be subjected to tensor operations and transmitted via two separate queue put operations: put queue-0 operation and put queue-1 operation. These two asynchronous queues may allow for early communication of the first partition of data to the consumer. Optimized consumer operations 308 may include corresponding get queue-0 and get queue-1 operations that retrieve the split tiles independently. The consumer agent may begin executing the first set of MMA instructions upon receiving the first tile, while the second tile is still in transition. Once the second tile is received, the consumer may complete the remaining set of MMA operations. This arrangement minimizes blocking, reduces synchronization latency, and maximizes throughput by overlapping communication and computation.

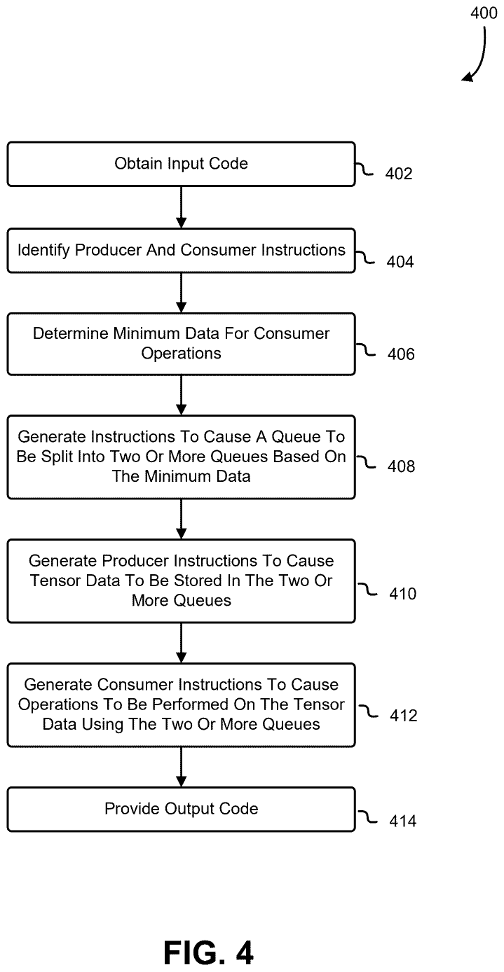

Now referring to FIG. 4, each block of process 400, described herein, comprises a computing process that may be performed using any combination of hardware, firmware, and/or software. For instance, various functions may be carried out using one or more processors executing instructions stored in one or more memories. The process may also be embodied as computer-usable instructions stored on computer storage media. The process may be provided by a standalone application, a service or hosted service (standalone or in combination with another hosted service), as a microservice via an application programming interface (API) or a plug-in to another product, to name a few. In addition, process 400 is described, by way of example, with respect to the system of FIG. 1. However, this process may additionally or alternatively be executed by any one system, or any combination of systems, including, but not limited to, those described herein (e.g., a compiler).

FIG. 4 is a flow diagram illustrating a process 400 of modifying code of a neural network to generate multiple queues, in accordance with at least one embodiment of the present disclosure. The process 400, at block 402, includes obtaining input code comprising one or more instructions corresponding to producer and consumer operations, such as a softmax agent and a math agent, respectively. Such a process step may involve reading compiler input that encodes tensor computations and queue-based data movement between different agents in an FMHA module of a neural network.

The process 400, at block 404, includes identifying producer and consumer instructions within the input code. Such a process step may involve scanning the compiler input for queue put and get operations, mapping them to corresponding agents, and/or associating them with surrounding tensor operations that produce or consume tiles of data.

The process 400, at block 406, includes determining the minimum amount of data required for one or more consumer instructions to begin execution. Such a process step may involve applying a compiler heuristic that identifies the smallest partition of a tensor tile sufficient to unblock early compute instructions or otherwise sufficient to perform operations, such as a subset of MMA operations. In some embodiments, this determination further considers hardware-imposed constraints, such as store granularity of a store instruction used to store data for the consumer instructions to consumer.

The process 400, at block 408, includes generating instructions to cause a queue to be split into two or more queues based, at least in part, on the minimum data requirement determined in block 406. Such a process step may involve generating instructions to replace the original queue with multiple asynchronous queues, each capable of transmitting a distinct portion of the original tile, thereby allowing earlier consumer-side execution and improved communication-computation overlap. In some embodiments, the queue to be split into multiple queues or to be replaced with multiple queues is the original queue indicated in the source code provided to the compiler as input. In some embodiments, the instructions generated are computer code that specifies how each queue is to be generated or otherwise allocated in memory and synchronized between producer and consumer threads. The generation of the code may be based on analysis of the producer-consumer operations and one or more compiler heuristics that determine how data should be partitioned for early consumption. The generated code may include instructions for queue initialization, memory binding, and enqueue/dequeue primitives adapted for asynchronous GPU execution.

The process 400, at block 410, includes generating producer instructions to cause the partitioned tensor data to be stored into the two or more queues. Such a process step may involve generating extract_slice operations to carve sub-tiles from the original tensor and associating each sub-tile with a corresponding queue. put operation. Each of these operations corresponds to a subset of the original tensor tile.

The process 400, at block 412, includes generating consumer instructions to cause operations to be performed on the tensor data retrieved using the two or more queues. Such a process step may involve inserting multiple queue get instructions and corresponding consumer-side operations (e.g., matrix multiplications) that operate on partially available tensor data, with dependency-aware scheduling to maximize compute overlap. The consumer instructions may cause operations to be performed on a portion of the tensor data retrieved through a first queue while other portions of the tensor data are being provided through the other queues.

The process 400, at block 414, includes providing output code comprising the transformed instructions suitable for execution on a target GPU platform. Such a process step may include IR with partitioned queue structures and adjusted tensor computations, suitable for hardware execution with finer-grained synchronization. The output code may include instructions generated as part of the process 400, and may be caused to be performed or otherwise executed by one or more processing units.

In some embodiments, the instructions generated in the above steps become part of the compiled code and cause the attention module in the compiled program to use multiple queues to transmit data between different agents, where a consumer can begin performing operations on a portion of data received from a producer through one of the queues, while one or more other portions of the data are still being transmitted through other queues. In some embodiments, a queue is considered to be between a first set of threads and a second set of threads when the queue is accessible to processing units (e.g., streaming multiprocessors or SMs) that are executing the two sets of threads. These queues may be stored in one or more memory regions that are accessible to such processing units. For example, the queues may reside in shared memory, global memory, or high-bandwidth memory accessible through an interconnect fabric or a memory controller. In some implementations, queues are located in a shared buffer region that is concurrently accessible to a first group of SMs executing producer threads and a second group of SMs executing consumer threads. In alternative embodiments, queues may be instantiated in memory regions local to each SM, where synchronization mechanisms—such as atomic operations or queue index coordination—ensure coherent data transfer across SMs. In yet other embodiments, queues may be implemented in a distributed memory address space, allowing producer and consumer thread groups to access queue data via explicit memory transfer operations or through a unified memory system that supports address space merging across processing units.

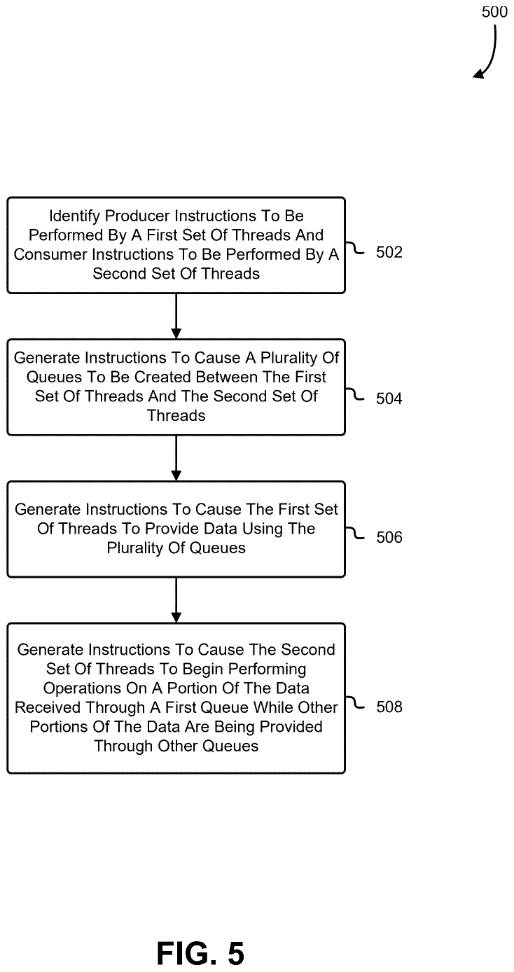

Now referring to FIG. 5, each block of process 500, described herein, comprises a computing process that may be performed using any combination of hardware, firmware, and/or software. For instance, various functions may be carried out using one or more processors executing instructions stored in one or more memories. The process may also be embodied as computer-usable instructions stored on computer storage media. The process may be provided by a standalone application, a service or hosted service (standalone or in combination with another hosted service), as a microservice via an application programming interface (API) or a plug-in to another product, to name a few. In addition, process 500 is described, by way of example, with respect to the system of FIG. 1. However, this process may additionally or alternatively be executed by any one system, or any combination of systems, including, but not limited to, those described herein (e.g., a compiler).

FIG. 5 is a flow diagram illustrating a process 500 of modifying code of a neural network to cause operations to be performed using multiple queues, in accordance with at least one embodiment of the present disclosure. The process 500, at block 502, includes identifying producer instructions to be performed by a first set of threads and consumer instructions to be performed by a second set of threads. Such a process step may involve analyzing compiler input code to detect different phases, such as softmax and matrix multiplication phases, within an FMHA module and associating each phase with distinct GPU thread sets/sub-groups (agents) specialized for producing or consuming tiles of tensor data.

The process 500, at block 504, includes generating instructions to cause a plurality of queues to be created between the first set of threads and the second set of threads. Such a process step may include determining, based on a store granularity or a compiler heuristic, the minimum data needed for the consumer to begin execution, and generating instructions to generate multiple asynchronous queues sized to transmit corresponding sub-tiles of tensor data between the identified agents. In some examples, the first set of threads and the second set of threads corresponds to a producer agent and a consumer agent, respectively. In some embodiments, the compiler heuristic is a rule or strategy used by the compiler to estimate the minimum amount of data a consumer thread needs before it can begin processing. When estimating the compiler heuristic, the compiler may consider hardware limits (such as store granularity), attention head dimensions, and/or instruction-level compute patterns (e.g., MMA granularity) to split data tiles into optimal sizes. This enables partial computation to start early, improving GPU utilization and reducing communication latency.

The process 500, at block 506, includes generating instructions to cause the first set of threads to provide data using the plurality of queues. Such a process step may involve modifying producer-side logic to include extract_slice operations that partition a full tensor tile into smaller sub-tiles based, e.g., on hardware-specific store granularity, such as 64 fp16 elements per store instruction. After generating each sub-tile, the process 500 may include inserting a corresponding store instruction to write that sub-tile into tensor memory. Each of these write operations may store only a portion of the full tile to memory. Following each partial store, the compiler may generate a queue put instruction to indicate that a portion of the tensor tile is available for consumption. This may enable asynchronous data transfer between the producer and consumer threads in smaller fragments, rather than requiring the entire tile to be stored and transferred at once. A processor causes a set of threads to begin performing operations by issuing or scheduling instructions that instantiate or activate the threads on one or more processing units (e.g., SMs, CPU cores, or other execution units). For example, the processor may generate or issue machine instructions or program code corresponding to the operations to be performed by the set of threads. These instructions may be loaded into instruction queues or execution contexts associated with processing units that are capable of performing thread-based execution. The processor may also allocate memory resources, assign thread identifiers, and bind the set of threads to specific hardware resources, thereby enabling the threads to be scheduled and executed by hardware. In some embodiments, causing a set of threads to perform operations includes initializing execution contexts (e.g., register states, stack frames, or program counters) and providing the necessary control signals or API calls to a runtime environment (e.g., CUDA, OpenCL, or a CPU thread scheduler), which in turn dispatches the threads to processing hardware. In some embodiments, causing a thread to perform a given operation may include directly issuing a thread-level instruction, signaling a runtime scheduler to assign a task to a thread, or instantiating a software or hardware structure (e.g., a kernel or function) that defines the operations for the thread to perform. Once the thread is dispatched, it begins executing the corresponding instructions to carry out the assigned task.

The process 500, at block 508, includes generating instructions to cause the second set of threads to begin performing operations on a portion of the data received through a first queue, while other portions of the data are being provided through other queues. Such a process step may involve inserting queue get operations to retrieve partial input and initiate matrix multiplication instructions on the consumer side without blocking for the complete tile, thereby improving overlap between communication and computation. For example, the consumer agent may begin performing operations on a first portion of the tile that has been received by the consumer agent through one queue while one or more other portions of the tile data are being transmitted through the one or more other queues.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models - such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures - such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation. In some examples, an input controller such as described in connection with FIG. 1 performs one or more processes such as those described herein to cause a plurality of queues to be created between a first set of threads and a second set of threads; and cause the second set of threads to begin performing operations on a portion of data received from the first set of threads through a first queue of the plurality of queues, while one or more other portions of the data are being transmitted through one or more other queues of the plurality of queues.

FIG. 6A is a block diagram of an example generative language model system 600 suitable for use in implementing at least some embodiments of the present disclosure. In the example illustrated in FIG. 6A, the generative language model system 600 includes a retrieval augmented generation (RAG) component 692, an input processor 605, a tokenizer 610, an embedding component 620, plug-ins/APIs 695, and a generative language model (LM) 630 (which may include an LLM, a SLM, a VLM, a multi-modal LM, etc.). The generative language model system 600 may be part of or otherwise implemented in connection with the LLM system as described in connection with FIG. 1.

At a high level, the input processor 605 may receive an input 601 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 630 (e.g., LLM/SLM/VLM/MMLM/etc.). In some embodiments, the input 601 includes plain text in the form of one or more sentences, paragraphs, and/or documents. Additionally or alternatively, the input 601 may include numerical sequences, precomputed embeddings (e.g., word or sentence embeddings), and/or structured data (e.g., in tabular formats, JSON, or XML). In some implementations in which the generative LM 630 is capable of processing multi-modal inputs, the input 601 may combine text (or may omit text) with image data, audio data, video data, design data, USD data, and/or other types of input data, such as but not limited to those described herein. Taking raw input text as an example, the input processor 605 may prepare raw input text in various ways. For example, the input processor 605 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 605 may remove stopwords to reduce noise and focus the generative LM 630 on more meaningful content. The input processor 605 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 692 (which may include one or more RAG models, and/or may be performed using the generative LM 630 itself) may be used to retrieve additional information to be used as part of the input 601 or prompt. RAG may be used to enhance the input to the LLM/SLM/VLM/MMLM/etc. with external knowledge, so that answers to specific questions or queries or requests are more relevant—such as in a case where specific knowledge is required. The RAG component 692 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 601 may be generated using the query or input to the model (e.g., a question, a request, etc.) in addition to data retrieved using the RAG component 692. In some embodiments, the input processor 605 may analyze the input 601 and communicate with the RAG component 692 (or the RAG component 692 may be part of the input processor 605, in embodiments) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 692 may retrieve a prior stored conversation history—or at least a summary thereof—and include the prior conversation history along with the current ask/request as part of the input 601 to the generative LM 630.

The RAG component 692 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 692 and the embeddings of the chunks along with the embeddings of the query may be compared to identify the most similar/related embeddings to the query, which may be supplied to the generative LM 630 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 692 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 610 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy may depend on factors such as the language being processed, the task at hand, and/or characteristics of the training dataset. As such, the tokenizer 610 may convert the (e.g., processed) text into a structured format according to tokenization schema being implemented in the particular embodiment.

The embedding component 620 may use any known embedding technique to transform discrete tokens into (e.g., dense, continuous vector) representations of semantic meaning. For example, the embedding component 620 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data/video data/etc., the input processor 601 may resize the data to a standard size compatible with format of a corresponding input channel and/or may normalize pixel values to a common range (e.g., 0 to 1) to ensure a consistent representation, and the embedding component 620 may encode the image data using any known technique (e.g., using one or more convolutional neural networks (CNNs) to extract visual features). In some implementations in which the input 601 includes audio data, the input processor 601 may resample an audio file to a consistent sampling rate for uniform processing, and the embedding component 620 may use any known technique to extract and encode audio features—such as in the form of a spectrogram (e.g., a mel-spectrogram). In some implementations in which the input 601 includes video data, the input processor 601 may extract frames or apply resizing to extracted frames, and the embedding component 620 may extract features such as optical flow embeddings or video embeddings and/or may encode temporal information or sequences of frames. In some implementations in which the input 601 includes multi-modal data, the embedding component 620 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 630 and/or other components of the generative LM system 600 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 620 may apply an encoded representation of the input 601 to the generative LM 630, and the generative LM 630 may process the encoded representation of the input 601 to generate an output 690, which may include responsive text and/or other types of data.

As described herein, in some embodiments, the generative LM 630 may be configured to access or use—or capable of accessing or using—plug-ins/APIs 695 (which may include one or more plug-ins, application programming interfaces (APIs), databases, data stores, repositories, etc.). For example, for certain tasks or operations that the generative LM 630 is not ideally suited for, the model may have instructions (e.g., as a result of training, and/or based on instructions in a given prompt, such as those retrieved using the RAG component 692) to access one or more plug-ins/APIs 695 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 695 to the plug-in/API 695, the plug-in/API 695 may process the information and return an answer to the generative LM 630, and the generative LM 630 may use the response to generate the output 690. This process may be repeated—e.g., recursively—for any number of iterations and using any number of plug-ins/APIs 695 until an output 690 that addresses each ask/question/request/process/operation/etc. from the input 601 can be generated. As such, the model(s) may not only rely on its own knowledge from training on a large dataset(s) and/or from data retrieved using the RAG component 692, but also on the expertise or optimized nature of one or more external resources—such as the plug-ins/APIs 695.

FIG. 6B is a block diagram of an example implementation in which the generative LM 630 includes a transformer encoder-decoder. For example, assume input text such as “Who discovered gravity” is tokenized (e.g., by the tokenizer 610 of FIG. 6A) into tokens such as words, and each token is encoded (e.g., by the embedding component 620 of FIG. 96A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 635 of the generative LM 630.

In an example implementation, the encoder(s) 635 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 640 may convert the context vector into attention vectors (keys and values) for the decoder(s) 645.

In an example implementation, the decoder(s) 645 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 635, in an example transformer architecture, each token (e.g., word) flows through a separate path in the decoder(s) 645. During a first pass, the decoder(s) 645, a classifier 650, and a generation mechanism 655 may generate a first token, and the generation mechanism 655 may apply the generated token as an input during a second pass. The process may repeat in a loop, successively generating and adding tokens (e.g., words) to the output from the preceding pass and applying the token embeddings of the composite sequence with positional encodings as an input to the decoder(s) 645 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 635, except that it creates its queries from the layer below it and takes the keys and values (e.g., matrix) from the output of the encoder(s) 635.

As such, the decoder(s) 645 may output some decoded (e.g., vector) representation of the input being applied during a particular pass. The classifier 650 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 655 may select or sample a word or token based on a corresponding predicted probability (e.g., select the word with the highest predicted probability) and append it to the output from a previous pass, generating each word or token sequentially. The generation mechanism 655 may repeat the process, triggering successive decoder inputs and corresponding predictions until selecting or sampling a symbol or token that represents the end of the response, at which point, the generation mechanism 655 may output the generated response.

FIG. 6C is a block diagram of an example implementation in which the generative LM 630 includes a decoder-only transformer architecture. For example, the decoder(s) 660 of FIG. 6C may operate similarly as the decoder(s) 645 of FIG. 6B except each of the decoder(s) 660 of FIG. 6C omits the encoder-decoder self-attention layer (since there is no encoder in this implementation). As such, the decoder(s) 660 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 660. As with the decoder(s) 645 of FIG. 6B, each token (e.g., word) may flow through a separate path in the decoder(s) 660, and the decoder(s) 660, a classifier 665, and a generation mechanism 670 may use auto-regression to sequentially generate one token at a time until predicting a symbol or token that represents the end of the response. The classifier 665 and the generation mechanism 670 may operate similarly as the classifier 650 and the generation mechanism 655 of FIG. 6B, with the generation mechanism 670 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment - and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
cause a plurality of queues to be created between a first set of threads and a second set of threads identified from a first computer program code; and
cause the second set of threads to begin performing operations on a portion of data received from the first set of threads through a first queue of the plurality of queues, while one or more other portions of the data are being transmitted through one or more other queues of the plurality of queues.

2. The one or more processors of claim 1, wherein the processing circuitry is to further cause a size of the portion of data received from the first set of threads to be determined based, at least in part, on a size of data to be stored as a result of performing a store instruction.

3. The one or more processors of claim 1, wherein the processing circuitry is to further cause a second computer program code to be generated to create the plurality of queues.

4. The one or more processors of claim 1, wherein the second set of threads is to perform one or more matrix multiply-accumulate (MMA) operations based, at least in part, on the portion of data.

5. The one or more processors of claim 1, wherein the portion of data and at least one other portion of the one or more other portions of the data are of a same size.

6. The one or more processors of claim 1, wherein the one or more processors include one or more graphics processing units (GPUs).

7. The one or more processors of claim 1, wherein the data includes one or more values of one or more tensors.

8. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

9. A system comprising one or more processors to:
identify a first set of threads and a second set of threads from input code;
cause output code to be generated to create a plurality of queues between a first set of threads and a second set of threads; and
cause the second set of threads to perform operations on one or more portions of data received from the first set of threads through a first queue of the plurality of queues while one or more other portions of the data are being transmitted through one or more other queues of the plurality of queues.

10. The system of claim 9, wherein the one or more processors are to cause the first set of threads to perform a put operation to provide the one or more portions of the data to the first queue.

11. The system of claim 9, wherein the data comprises one or more tensors.

12. The system of claim 9, wherein the one or more processors are to cause the second set of threads to perform a get operation to obtain the one or more portions of the data from the first queue.

13. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

14. A method comprising:
identifying one or more producer operations to be performed by a first set of threads and one or more consumer operations to be performed by a second set of threads;
causing a plurality of queues to be generated based, at least in part, on the one or more producer operations and the one or more consumer operations; and
causing the second set of threads to perform operations on a portion of data received from the first set of threads through a first queue of the plurality of queues, while one or more other portions of the data are being provided through one or more other queues of the plurality of queues.

15. The method of claim 14, further comprising causing the second set of threads to perform other operations on another portion of the data received from a second queue of the plurality of queues.

16. The method of claim 14, wherein the second set of threads is to perform one or more matrix multiply-accumulate (MMA) instructions using the portion of the data received from the first set of threads.

17. The method of claim 14, wherein the plurality of queues is located in one or more memory locations accessible to one or more processing units performing the first set of threads and the second set of threads.

18. The method of claim 14, further comprising identifying the one or more producer operations and the one or more consumer operations based, at least in part, on computer program code.

19. The method of claim 14, further comprising generating one or more instructions to cause the plurality of queues to be generated.

20. The method of claim 14, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.
